(19) United States
(12) Patent Application Publication
(10) Pub. No.: US 2014/0282173 A1
(43) Pub. Date: Sep. 18, 2014

(54) TRANSIENT SYNTHESIZED CONTROL TO MINIMIZE COMPUTER USER FATIGUE

(71) Applicant: COREL CORPORATION, Ottawa (CA)

(72) Inventor: Hendrik Jouwert Wagenaar, Ottawa (CA)

(73) Assignee: Corel Corporation, Ottawa (CA)

(21) Appl. No.: 13/826,974

(22) Filed: Mar. 14, 2013

(51) Int. Cl. G06F 3/0484

(52) U.S. Cl. CPC G06F 3/0484
USPC 715/771

(57) ABSTRACT

A method includes the steps of: providing a computer readable non-transitory storage medium including a computer readable code configured to run on a local computer and configured to perform a process to display a transient synthesized control for user adjustment; running the computer readable code on the local computer; detecting by computer a user request to display the transient synthesized control; recording by computer a position of an on-screen position indicator in a drawing area; displaying by computer the transient synthesized control; detecting by computer a user request to remove the display of the transient synthesized control; and redrawing by computer the drawing area as it appeared before the display of the transient synthesized control and restoring the on-screen position indicator. A system to perform the method is also described.

### FIELD OF THE INVENTION

The invention relates to controlling features of a computer program and more particularly to a system and method for displaying software controls.

### BACKGROUND OF THE INVENTION

A computer graphics program such as a computer drawing program typically has a tool bar area and a drawing area. The tool bar area is usually along the top of the computer display viewing area. The drawing area is generally located below the tool bar. Some tool bars might also be displayed vertically along the left or right side of the display viewing area.

The tool bar options of a computer graphics programs can be very rich, offering many adjustments that affect the way a particular tool or feature operates. For example, a drawing tool might be a pencil type tool that can draw a line in the drawing area. One example of a settable parameter for a pencil drawing tool is line width. Typically a user can set a line width using a control in a tool bar. For example, the user can enter a numerical value for a line width or in many cases adjust a sliding indicator along a predefined track in the tool bar.

A user of a computer graphics program can become proficient at learning short cuts to make a particular control in a tool bar active. Once a tool has been selected, usually by moving the mouse arrow to the control, clicking on the mouse, and dragging the mouse to move the control, the user can set a new value by so adjusting a control in a tool bar. Usually the user moves the user's eyes, or more likely the user's head and eyes when they look from the work being created or edited to the tool bar.

### SUMMARY OF THE INVENTION

According to one aspect, the invention features a method which includes the steps of: providing a computer readable non-transitory storage medium including a computer readable code configured to run on a local computer and configured to perform a process to display a transient synthesized control for user adjustment; running the computer readable code on the local computer; detecting by computer a user request to display the transient synthesized control; recording by computer a position of an on-screen position indicator in a drawing area; displaying by computer the transient synthesized control; detecting by computer a user request to remove the display of the transient synthesized control; and redrawing by computer the drawing area as it appeared before the display of the transient synthesized control and restoring the on-screen position indicator.

In one embodiment, the transient synthesized control includes a transient synthesized slider control.

In another embodiment, the step of detecting by computer a user request includes detecting by computer a user request made by operating a key of a keyboard to display the transient synthesized control.

In yet another embodiment, an on-screen position of the on-screen position indicator is controlled by a user entry device.

In yet another embodiment, the user entry device includes a mouse.

In yet another embodiment, the step of detecting by computer a user request to display the transient synthesized control further includes operation of a keyboard key and a dragging motion of a mouse.

In yet another embodiment, the step of displaying by computer the transient synthesized control includes displaying a transient synthesized smear amount control.

In yet another embodiment, the step of displaying by computer the transient synthesized control includes displaying a transient synthesized transparency control.

In yet another embodiment, the step of displaying by computer the transient synthesized control includes displaying a transient synthesized rate control.

In yet another embodiment, the rate control includes a twirl rate control.

In yet another embodiment, the step of displaying by computer the transient synthesized control includes displaying a transient synthesized brush control.

In yet another embodiment, the brush control includes a brush pressure.

In yet another embodiment, the step of displaying by computer the transient synthesized control includes displaying a transient synthesized pen control.

In yet another embodiment, the pen control includes a pen pressure.

According to one aspect, the invention features a system which includes a computer readable code configured to run on a local computer including a user entry device. The computer readable code is configured to perform a process to display a transient synthesized control for user adjustment and to detect by computer a user request to display the transient synthesized control, to record by computer a position of an on-screen position indicator in a drawing area, to display by computer the transient synthesized control, to detect by computer a user request to remove the display of the transient synthesized control, and to redraw by computer the drawing area as it appeared before the display of the transient synthesized control and to restore the recorded a position of an on-screen position indicator.

In one embodiment, the user entry device includes a mouse.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A shows an illustration of a transient synthesized control as slider that is bound to the pressure of the brush;

FIG. 1B is an illustration showing the current width of the brush of FIG. 1A;

FIG. 1C shows the slider of FIG. 1A after increasing the pressure;

FIG. 1D shows the modified width caused by the increase in the pressure as shown in FIG. 1C;

FIG. 2A shows an illustration of a transient synthesized control as an exemplary slider control bound to a non-width transparency parameter;

FIG. 2B shows an illustration of the slider control of FIG. 2A set for less transparency;

FIG. 3 shows a block diagram of one embodiment of steps to perform the process; and

FIG. 4 shows an illustration of a system suitable to perform the process of FIG. 3.

### DETAILED DESCRIPTION

As described hereinabove, there are generally a wide variety of user controls in one or more tool bars of a computer graphics program. In many modern computer drawing programs, the controls offer a rich array of tool settings from pencil line width, pen nib pressure and line width to adjusting brush size, intensity or other brush aspects, etc. The problem is that each time a user navigates to a control, the user needs to move their eyes and often their head as well to look from the drawing area to the control being manipulated in a tool bar. Once the control has been adjusted, the user needs to move the mouse or other suitable user entry device as well as their eyes and often with another movement of the head to return the mouse position to the point presently being edited. For many users, constant eye and head movement between the drawing and the tool bars is exhausting.

There is a need for more efficient and more ergonomic displayed tool controls.

It was realized that a far less taxing control system and method to present a control to a user, is to synthesize the control (e.g. a control equivalent to a corresponding control in a tool bar) on the drawing screen near where the user is currently drawing. The synthesized control can be transient, only appearing in the drawing space when needed to set a particular controllable parameter (most commonly a tool setting). Moreover, it was realized that immediately prior to displaying the synthesized control, the present user entry device pointer position (typically an on-screen mouse pointer or mouse arrow position) can be recorded by computer. Following synthesis of the tool and user adjustment via the synthesized control, the mouse indicator (e.g. an arrow) can be then be returned to substantially the same point as when the user first called for the tool to appear.

It has been found that by using this system and method of both recording and restoring a mouse position, and displaying a transient synthesized control at about a point on a drawing area where a user is presently looking, that user fatigue and stress from repetitive eye and head movement caused by repeated movement to and from the tool bars can be reduced or substantially eliminated.

In one generalized embodiment, the steps of the process include: recording the on-screen position indicator (e.g. an on-screen mouse indicator position), displaying a transient synthesized control at about a point on a drawing area about the same location where a user is presently looking, allowing a user to make an adjustment using the displayed a transient synthesized control, sensing completion of user adjustments, and returning the on-screen mouse position to substantially the original position before the control was requested. This process is believed to be generally applicable to any type of user adjustment where it can be desirable to limit user eye and head movement during adjustment of some parameter of a computer program.

### Example

In computer drawing program, the size and pressure of a pen nib tool can be adjusted. According to one embodiment, the user, without moving their point of attention in the drawing area, can press a predetermined key, here an “alt” key combined with a mouse dragging motion. The computer program records the present position of the mouse cursor in the drawing area (i.e. the on-screen mouse position). A control, such as a slider control, is then synthesized and drawn very near or substantially at that point in the drawing area. The user adjusts the pressure parameter by holding the mouse button down while moving the slider position and then releases the mouse button, indicating that they have completed the pressure adjustment. The computer registers the adjustment, and the computer then redraws or re-renders the drawing or an area of the drawing so that the transient synthesized control, here a slider, disappears from the user view. Following removal of the transient synthesized control, the displayed drawing area where the tool was returns to its appearance before the synthesized control was shown. The on-screen mouse indication is returned to substantially the same position it was in before the tool control was called for. The user can now continue drawing with the new value set by the control. A similar adjustment can be made by pressing the “shift” key and dragging a mouse to adjust the nib size.

### Example

FIG. 1A, FIG. 1B, FIG. 1C and FIG. 1D show partial screen renderings. A transient synthesized control in the form of a slider is bound to the pressure parameter of a brush tool. FIG. 1A shows an appearance of the slider control in the upper left corner of a drawing area at about location 103. The user had been editing at about point 103 before requesting a display of the brush pressure slider control. Slider control 101 shows the present brush pressure setting by the horizontal (right-left) position of slide pointer, presently at slider position 102a. In other embodiments, there can be up-down or any another other suitable slider direction of motion. FIG. 1B shows the same drawing area after the slider control was removed following a user exit indication. In this exemplary embodiment, a circle 105a shows the user the present line width from which the user can begin to draw, resuming editing from point 103 on the display screen. However, the user has decided to adjust the brush pressure before drawing. FIG. 1C shows the re-appearance at user request of the width slider 101. Now, the user moves the slider pointer to a slider position 102b, thus increasing the pressure. Once the user makes a user exit indication, the transient synthesized control (slider control 101) disappears and a new larger sized circle 105b shows the user a guide of the new width corresponding to the increased brush pressure. FIG. 1D shows the modified width, in some embodiments, the cursor will be at the perimeter of the circle, then, when the user lets go of the mouse button, the cursor will return to the center of the circle, and the user can begin drawing from point 103. Throughout the steps shown in FIG. 1A, FIG. 1B, FIG. 1C and FIG. 1D, the user has not had to move the users eyes or head to make an adjustment in a toolbar.

Controls for pen or pencil properties such as nib size are described herein merely to demonstrate exemplary on-screen adjustments of width parameters. Other such controls can also be bound to non-width parameters of a tool. Exemplary non-width controls include, for example, on-screen sliders to adjust pressure, effect rate, rate, such as, for example, twirl rate, smear amount, non-width brush parameters, and transparency.

### Example

FIG. 2A and FIG. 2B show an on-screen slider bar as a transient synthesized control according the process described herein which is bound to a non-width parameter, transparency of brush strokes. In FIG. 2A, the user has requested the appearance of a transient synthesized control 201. The user sets the slider pointer to a slider position 202a, in this case adjusting to the right for more transparency as can be seen by line 203. In this embodiment, the transient synthesized control is shown momentarily near the object being edited. However, when the user makes the exit indication, the transient synthesized control 201 goes away (not shown in FIG. 2A) and the on-screen location of editing is restored to the same location as just before the appearance of the control. The user then calls back the transient synthesized control 201 and adjusts the slider position 202b to the left, indicating less transparency as represented by the darker line in FIG. 2B. Finally, after the transient synthesized control 201 disappears, the editing location will be restored to the same location as before the transient synthesized control 201 was called for (not shown in FIG. 2B).

The transient synthesized control can by any type of suitable control, or list of selectable items. A slider is but one exemplary type of control suitable for use as a transient synthesized control. For example, there can be a transient synthesized pen control, such as, for example, to control pen width, or pen pressure. There could also be display of an adjustable knob or any other suitable representation of an adjustable control. A transient synthesized control can also be presented as a list of items from which a user can select an item of the list.

Any suitable user prompts can be used to tell the computer process that the user is calling for a transient synthesized control. Similarly, any suitable user prompts can be used to tell the computer process that the user has completed the adjustment using the transient synthesized control and is ready to resume drawing or editing at substantially the same point on the drawing. For example, in some embodiments, a user press of a keyboard key combined with pressing a mouse button and a slight dragging motion of a mouse can tell the process the user is calling for a particular transient synthesized control to be displayed for use. Releasing the mouse button can be used as an exit event to indicate to the process that the user has completed the adjustment using the transient synthesized control and wants to return to working at or near the point in the drawing where they were looking before they called for the transient synthesized control to be displayed.

It will be understood by those skilled in the art that a transient synthesized control can be created in a scale suitable for any particular drawing view. For example, where a user has zoomed in “tight” on a portion of the drawing, the transient synthesized control can be scaled to appear to be roughly a standard control size to the user.

### Example

One exemplary embodiment of code which can be used to perform the process as described herein follows:

onMouseButtonPressedEvent( ) { // mouse button down event

| | |
|---|---|
| if(modifierKeyIsDown) { | // is the key (e.g. alt) currently |
| | // being held |
| RememberMousePosition( ); | // remember the mouse position, to |
| | // be restored later |

| | |
|---|---|
| DrawTransientSliderControl( ); | // draw the on screen slider |
| while(mouseButtonIsPressed) { | // loop while the user is holding |
| | // mouse down |
| if( mouseMoved ) { | // if the user moves the mouse, |
| | // update everything |

```
        CalculateSliderPositionBasedOnMousePosition( )
        DrawTransientSliderControl( );
```

| | |
|---|---|
| UpdateListenersOfSliderValue( ); | // here we tell the tool and |
| | // other contols the new value |
| | // of whatever the slider |
| | // modifies (pressure, rate, |
| | // etc.) |
| } | |
| } | |

| | |
|---|---|
| EraseTransientSliderControl( ); | // remove the onscreen control |
| RestoreMousePosition( ); | // return the mouse location |
| } | |

else {...} // remaining implementation of tool
}

While a mouse which can cause an on-screen mouse indication (e.g. an arrow or any other suitable indication symbol) is used to described some exemplary embodiments of the processes as described hereinabove, those skilled in the art will understand that any suitable user entry device and any suitable on-screen position indicating symbol can be used. Accordingly, where another type of user entry device is used, it is understood that the terms mouse position and mouse cursor or mouse arrow refer to any suitable on-screen position indication of a user entry point or user editing point as determined by the user entry device.

FIG. 3 shows one exemplary process including the steps of: A) provide a computer readable non-transitory storage medium including a computer readable code configured to run on a local computer and configured to perform a process to display a transient synthesized control for user adjustment; B) run the computer readable code on the local computer; C) detect by computer a user request to display the transient synthesized control; D) record by computer a position of an on-screen position indicator in a drawing area; E) displaying by computer the transient synthesized control; F) detect by computer a user request to remove the display of the transient synthesized control; and G) redraw by computer the drawing area as it appeared before the display of the transient synthesized control and restoring the on-screen position indicator.

FIG. 4 shows a block diagram of a computer system 400 suitable to perform the processes as described herein. Computer 401 has associated with it a user input device 403, such as for example a computer mouse, keyboard 407, and a computer display 405. The computer readable code configured to run on a computer 401 can reside on any suitable computer readable non-transitory storage medium such as for example a CD, DVD, hard drive, solid state drive, etc. (not shown in FIG. 4). A computer suitable to perform the processes described hereinabove can include any suitable type of computer, such as for example, a personal computer having any suitable operating system. It is further contemplated that the inventive processes as described herein can be practiced on any suitable computer based device having a computer processor or firmware which simulates the functions of a computer processor.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A method comprising the steps of:
providing a computer readable non-transitory storage medium comprising a computer readable code configured to run on a local computer and configured to perform a process to display a transient synthesized control for user adjustment;
running said computer readable code on said local computer;
detecting by computer a user request to display said transient synthesized control;
recording by computer a position of an on-screen position indicator in a drawing area;
displaying by computer said transient synthesized control;
detecting by computer a user request to remove said display of said transient synthesized control; and
redrawing by computer said drawing area as it appeared before said display of said transient synthesized control and restoring said on-screen position indicator.

2. The method of claim 1, wherein said transient synthesized control comprises a transient synthesized slider control.

3. The method of claim 1, wherein said step of detecting by computer a user request comprises detecting by computer a user request made by operating a key of a keyboard to display said transient synthesized control.

4. The method of claim 1, wherein an on-screen position of said on-screen position indicator is controlled by a user entry device.

5. The method of claim 4, wherein said user entry device comprises a mouse.

6. The method of claim 5, wherein said step of detecting by computer a user request to display said transient synthesized control further comprises operation of a keyboard key and a dragging motion of a mouse.

7. The method of claim 1, wherein said step of displaying by computer said transient synthesized control comprises displaying a transient synthesized smear amount control.

8. The method of claim 1, wherein said step of displaying by computer said transient synthesized control comprises displaying a transient synthesized transparency control.

9. The method of claim 1, wherein said step of displaying by computer said transient synthesized control comprises displaying a transient synthesized rate control.

10. The method of claim 9, wherein said rate control comprises a twirl rate control.

11. The method of claim 1, wherein said step of displaying by computer said transient synthesized control comprises displaying a transient synthesized brush control.

12. The method of claim 11, wherein said brush control comprises a brush pressure.

13. The method of claim 1, wherein said step of displaying by computer said transient synthesized control comprises displaying a transient synthesized pen control.

14. The method of claim 13, wherein said pen control comprises a pen pressure.

15. A system comprising: a computer readable code configured to run on a local computer comprising a user entry device, said computer readable code configured to perform a process to display a transient synthesized control for user adjustment and to detect by computer a user request to display said transient synthesized control, to record by computer a position of an on-screen position indicator in a drawing area, to display by computer said transient synthesized control, to detect by computer a user request to remove said display of said transient synthesized control, and to redraw by computer said drawing area as it appeared before said display of said transient synthesized control and to restore said recorded a position of an on-screen position indicator.

16. The system of claim 15, wherein said user entry device comprises a mouse.
